(19) United States
(12) Patent Application Publication
(10) Pub. No.: US 2003/0004839 A1
(43) Pub. Date: Jan. 2, 2003

(54) Computerized automatic management system and method for logistics control

(76) Inventors: Kuang-Shin Lin, Taipei (TW); Jeff Song, Taipei (TW); Xiao-Ling Liu, Tianjin (CN)

Correspondence Address: BIRCH STEWART KOLASCH & BIRCH, PO BOX 747, FALLS CHURCH, VA, 22040-0747, US

(21) Appl. No.: 10/179,965

(22) Filed: Jun. 26, 2002

(30) Foreign Application Priority Data
Jun. 27, 2001 (TW) 90115500

(51) Int. Cl. G06F 17/60

(52) U.S. Cl. 705/28

(57) ABSTRACT

A computerized automatic management system for logistic control is disclosed. It contains at least a good arrival-processing module, a good picking processing module, and a good delivery-processing module. The good arrival-processing module produces a good arrival checklist and a good arrival acceptance list according to a good arrival/return note. The good picking-processing module selects goods after scheduling delivery trucks and optimizing storage locations. The good delivery processing module loads the goods according to a delivery list printed out after scheduling the delivery trucks, confirms the loading result, and, after the goods are shipped out, confirms the shipping result. The invention also discloses a computerized automatic management method for logistics control.

### BACKGROUND OF THE INVENTION

1. Field of the Invention

The invention relates to a warehouse management system and corresponding method and, in particular, to a computerized automatic management system and a method for logistics control

2. Related Art

In conventional logistics systems, stock performs the roles of “storage” and “conservation”. However, under the pressures of new consumer demands, huge amounts of complicated data, and competitive markets, goods must enter and leave a stock system in a rapid and complicated manner so as to achieve proper timing and satisfy the market's requirements of quantity and variety. Therefore, a dynamic management function for warehouse systems has become more important than the simple conservation function in conventional warehousing. The dynamic management function combines the conventional stock system and the currently popular data stock system. The purpose of such a combination is to plan and manage storage space so as to effectively control the sources, destinations and fluctuations of commodities.

Nowadays, many stock management systems do not have a sufficient number of functions. Without a client operating interface, the following situations occur: (a) the client rents space from a host stock and directly operates using the client's stock management system; (b) the client does not use its own stock management system and the host enters data for the client; and (c) stock operation information is entered repetitively (in both the client and the host systems). This is all because the logistics information cannot be transmitted or shared, causing a vicious circle of production distribution quality.

Therefore, computerization of business administration is a necessary means to increase the competitive power of an enterprise. A logistics company can make more advanced management of the arrivals and deliveries of materials through computerization, increasing the management level and processing efficiency of daily business. The collection of statistics and information can thus be more real-time and accurate.

Consequently, a computerized automatic management system and corresponding method for logistic control are important subjects of study in the field.

### SUMMARY OF THE INVENTION

The invention adopts a client/server design model. An objective of the invention is to provide a web page on an Intranet as the human-machine interface to implement the automatic management of the logistic, increasing the operation efficiency of production-distribution businesses.

The disclosed computerized automatic management system for logistics control includes at least a good arrival processing module, a good picking module, and a good delivery module. The good arrival module generates a good arrival checklist and a good acceptance list according to a good arrival/return note in order to process the arrival of good. The good picking module schedules delivery trucks and optimizes storage locations according to a goods delivery note from a client and then processes goods picking. After the goods are selected, the good delivery module loads goods according to a delivery list and confirms the loading result. After the goods are shipped out, the good delivery module confirms the shipping result and completes delivery of the good.

The invention also discloses a computerized automatic management method for logistics control. The method includes the steps of: entering a good arrival/return note, printing a good arrival checklist according to the good arrival/return note; entering actual accepted items and quantities to complete the good arrival; outputting a good delivery note, scheduling delivery trucks, optimizing storage locations and preparing data according to the good delivery route; printing a good picking list, a good delivery list, and a route list; picking goods and confirming the good picking; loading the goods according to the good delivery list and confirming the loading result; shipping the goods and confirming the shipping result; confirming the delivery result and closing the case to complete the good delivery.

### BRIEF DESCRIPTION OF THE DRAWINGS

The invention will become more fully understood from the detailed description given hereinbelow. However, this description is for purposes of illustration only, and thus is not limitative of the invention, wherein:

FIG. 1 is a block diagram showing the main functional module of the invention;

FIG. 2 is an execution flowchart of the good arrival-processing module;

FIG. 3 is an execution flowchart of the good picking-processing module;

FIG. 4 is an execution flowchart of the good delivery processing module; and

FIG. 5 is a flowchart showing a preferred embodiment of the invention.

### DETAILED DESCRIPTION OF THE INVENTION

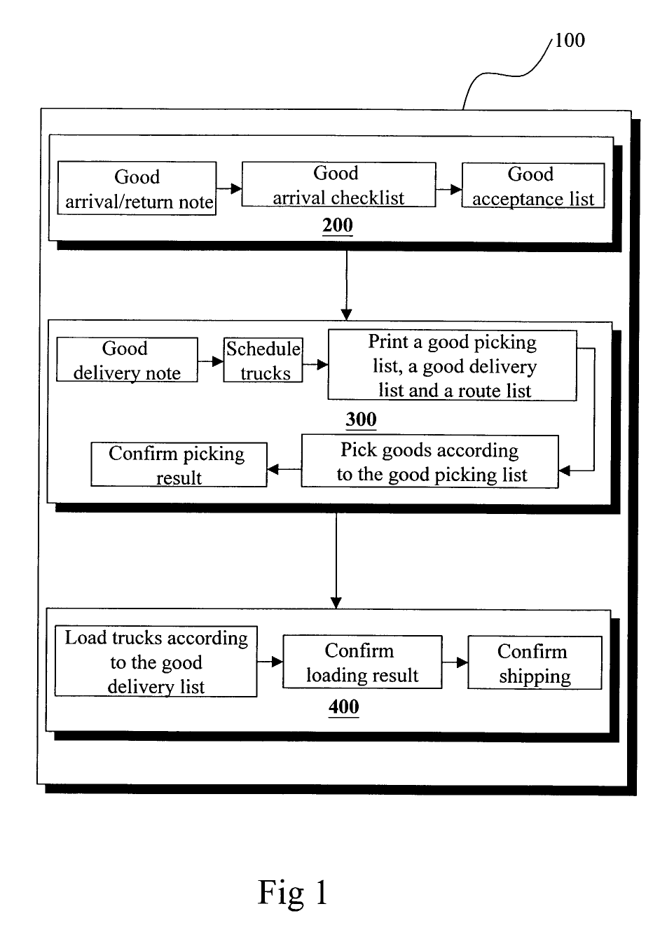

As shown in FIG. 1, the main functional module 100 includes a good arrival processing module 200, a good picking-processing module 300 and a good delivery-processing module 400.

The good arrival processing module 200 performs good arrival and stocking according to the following situations: (a) a client provides a good arrival note to request good arrival; (b) a client provides a good return note to request good return; (c) some goods are returned after delivery due to some mistake made by the company or the client and they need to be stocked again. A good arrival/return note is used in the above situations to generate a good arrival checklist and a good acceptance list to process good arrival.

The main function of the good picking module 300, after scheduling trucks and optimizing storage locations, is to print a good picking list, a good delivery list and a route list according to the good delivery note provided by the client. It tells a stock manager the storage locations and quantities of requested goods. The goods are selected and put on a platform for confirming the good picking result.

After good picking, the good delivery processing module 400 loads the goods according to the good delivery list printed after scheduling delivery trucks and confirms the loading result. After the goods are shipped out, it confirms the shipping result. If there is any mistake in the shipping, the module 400 fills an error form to process the re-arrival of the goods.

The detailed operations of the good arrival processing module 200, the good picking processing module 300 and the good delivery processing module 400 are described individually as follows.

(1) The Good Arrival Processing Module 200:

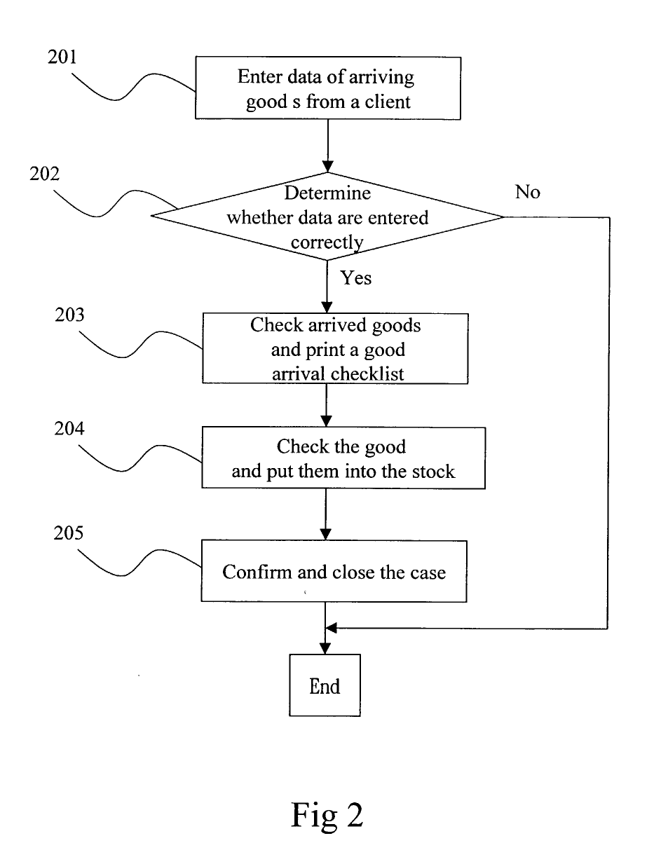

As shown in FIG. 2, step 201 enters data of goods that will arrive. Step 202 determines whether data are entered correctly. If no good is arriving, the procedure ends. If there are goods arriving, they are checked and distributed into predetermined storage locations for arrived goods if accepted. A good arrival checklist is also printed (step 203). Step 204 checks the goods and puts them into the stock. The actual items and quantities being accepted and the storage locations are then put down in the good arrival checklist and the case is closed and confirmed (step 205). After the good arrival is completed, the accepted goods will be selected and delivered in the subsequent procedures.

(2) The Good Picking Processing Module 300:

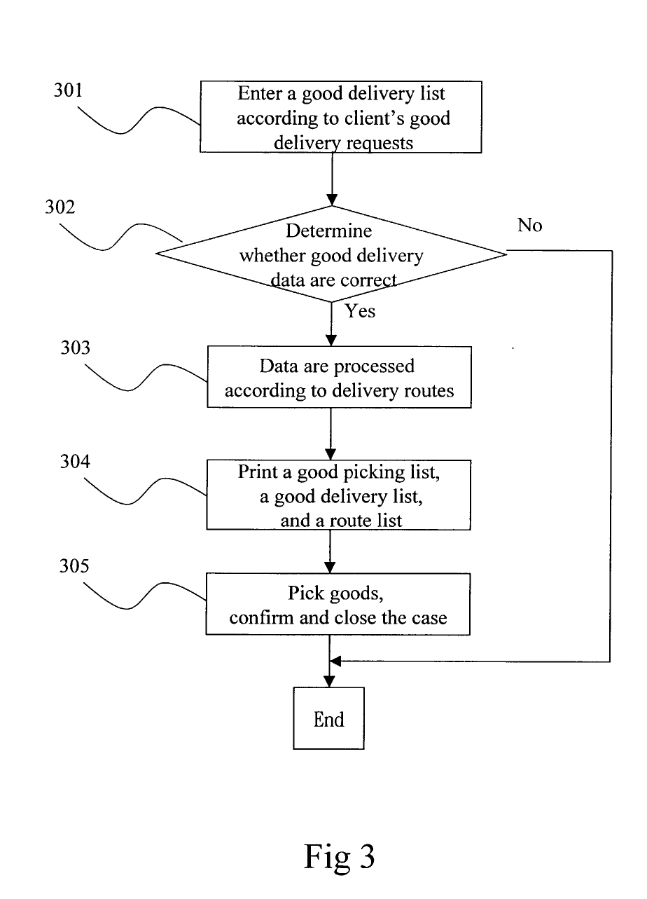

As shown in FIG. 3, step 301 enters a good delivery list according to a client's good delivery requests. Step 302 determines whether they are correct good delivery data. If there is no good delivery list, the procedure ends. Otherwise, data are processed according to delivery routes (step 303). Step 304 prints a good picking list, a good delivery list, and a route list. The good-picking list gives a good storage location and quantity for each good. Therefore, the goods can be readily selected according to the good picking list. Step 305 enters the actual storage locations and quantities of the selected goods to a good delivery main file and a good delivery detail file in the database, confirm the selection and closes the case. The selected goods will be loaded and delivered.

(3) The Good Delivery Processing Module 400:

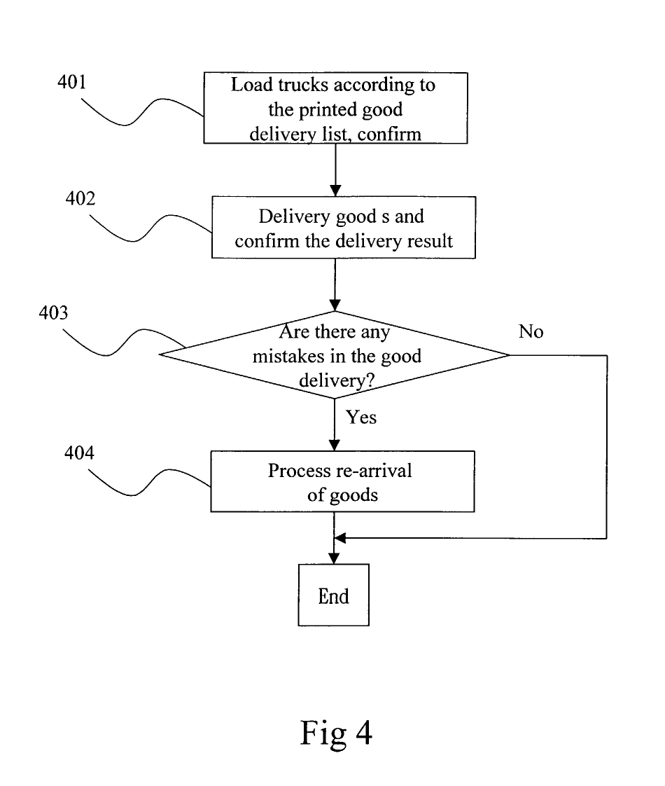

As shown in FIG. 4, goods are loaded into trucks according to the printed good delivery list. The actual quantities are confirmed and the case is closed (step 401). The goods are then shipped according to the delivery routes printed on the route list. Finally, the delivery result and the truck shipping record are stored and confirmed (step 402). Step 403 determines whether there are any mistakes in the good delivery. If there are no mistakes, the procedure ends. If some goods are returned for some reason, they have to be processed for re-arrival (step 404).

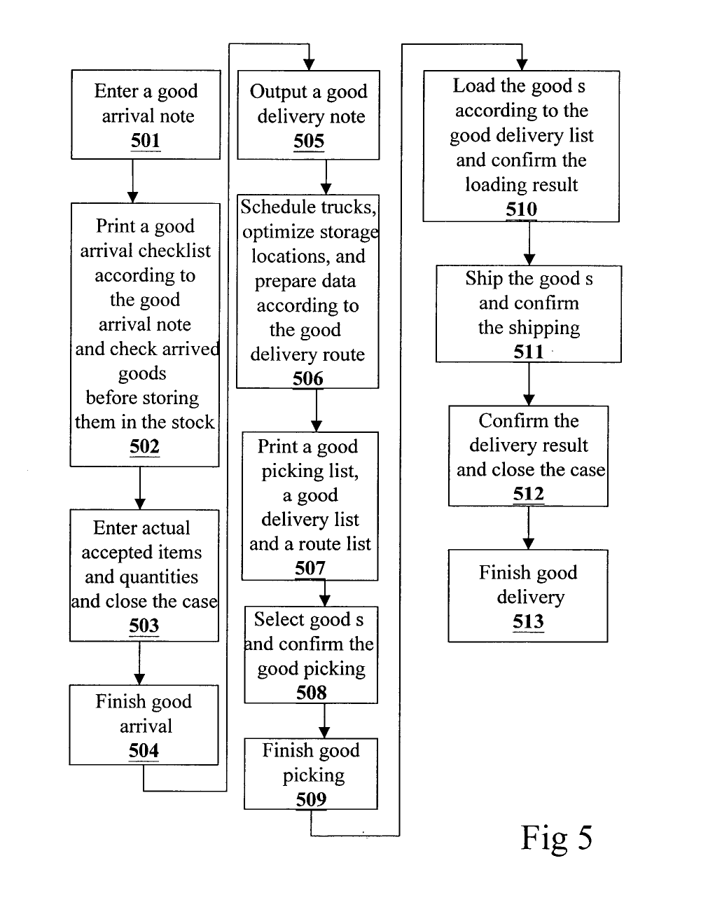

FIG. 5 illustrates how the techniques disclosed are implemented.

The commodity arrival module: When a client (some company) has a good arrival request, the good arrival note provided by the client is entered in step 501. In the checking procedure, all arrived goods are checked according to the printed good arrival checklist and filed into predetermined good storage locations in step 502. Step 503 enters the actual accepted items and quantities and closes the case. Step 504 ends the good arrival procedure.

The good picking module: Suppose a client (some company) has a good delivery request for sending goods to the headquarters of some supermarket. Step 505 enters the client's good delivery note. Step 506 schedules trucks, optimizes storage locations, and processes data according to good delivery routes. That is, data are processed according to the good delivery destinations. Step 507 prints a good delivery list, a good picking list and a route list (giving truck delivery routes). Step 508 selects goods according to the good picking list and confirms the selection result. Step 509 ends the good picking procedure.

The good delivery module: Goods are loaded into trucks according to the good delivery list in step 510. The trucks deliver the goods according to the route list and the shipping is confirmed in step 511. Step 512 confirms the good delivery result and closes the case. Step 513 finishes the good delivery procedure.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A computerized automatic management system for logistics control, which comprises:
a good arrival processing module, which generates a good arrival checklist and a good acceptance list according to a good arrival/return note to process good arrival;
a good picking processing module, which schedules trucks and optimize storage locations according to a good delivery note provided by a client to process good picking; and
a good delivery processing module, which loads goods according to a good delivery list printed after the good picking and confirms the loading result, and, after the goods being shipped out, confirms the shipping result.

2. The system of claim 1, wherein the good arrival-processing module also accepts re-arrival of returned goods due to good delivery mistakes.

3. The system of claim 1, wherein the good picking processing module further prints a good picking list, a good delivery list and a route list.

4. The system of claim 1, wherein the good delivery-processing module also fills out a delivery error form for processing re-arrival of returned goods.

5. A computerized automatic management method for logistics control, which comprises the steps of:
entering a good arrival/return note;
printing a good arrival checklist according to the good arrival/return note and checking and stocking the accepted goods;
registering actual stocked goods, thus finishing good arrival;
entering a good delivery note;
scheduling trucks, optimizing storage locations, and preparing data according to a good delivery route;
printing a good picking list, a good delivery list and a route list;
picking goods and confirming the picking, thus completing good picking;
loading the goods according to the good delivery list and confirming the loading result;
shipping the goods and confirming the shipping; and
confirming the delivery result and closing the case, thus completing good delivery.

6. The method of claim 5, wherein the good arrival/return note also includes the situation for re-arrival of returned goods due to good delivery mistakes.

7. The method of claim 5, wherein the step of checking and stocking the accepted goods distributes the accepted goods to predetermined storage locations.

8. The method of claim 5, wherein the step of confirming the delivery result and closing the case includes the step of filling out a delivery error form for processing re-arrival of returned goods.
